(19) United States
(12) Patent Application Publication
(10) Pub. No.: US 2007/0185634 A1
(43) Pub. Date: Aug. 9, 2007

(54) Method and system for controlling a driver-assistance device

(76) Inventors: Michael Weilkes, Sachsenheim (DE); Fred Oechsle, Ludwigsburg (DE); Ulf Wilhelm, Rutesheim (DE)

Correspondence Address: KENYON & KENYON LLP, ONE BROADWAY, NEW YORK, NY, 10004, US

(21) Appl. No.: 10/552,402

(22) PCT Filed: Mar. 26, 2004
(86) PCT No.: PCT/DE04/00636

§ 371 Date: Jul. 12, 2006

(30) Foreign Application Priority Data
Apr. 7, 2003 (DE) 10315819.7

(51) Int. Cl. B60R 22/00

(52) U.S. Cl. 701/45; 701/36; 280/735; 180/271

(57) ABSTRACT

In a method and a system for controlling a driver-assistance device, in which measured quantities to be recorded by sensors are evaluated for triggering a reaction, and measuring instants are determined through essentially repeating cycles for acquiring and evaluating the measured quantities, the measuring instants are controlled in such a way that one of the measuring instants follows as immediately as possible an instant at which measured quantities giving rise to a triggering probably exist.

### FIELD OF THE INVENTION

The present invention relates to a method and a system for controlling a driver-assistance device, in which measured quantities to be recorded by sensors are evaluated for triggering a reaction, and measuring instants are determined through essentially repeating cycles for acquiring and evaluating the measured quantities.

### BACKGROUND INFORMATION

Driver-assistance systems are devices in motor vehicles which evaluate information (measured quantities) from the vehicle surroundings, having, for example, radar, lidar and/or video sensors. These measured quantities to be recorded in each case by sensors come in particular from the vehicle surroundings. In question here are distance, direction and size relative to other vehicles or to stationary objects and roadway edges and markings. Further measured quantities to be recorded by sensors relate to the vehicle, e.g., the specific velocity or the steering angle. Depending on the complexity of the specific evaluation and the computing capacity available, such systems sometimes have considerable cycle times. Thus, the systems do not supply a continuous picture of the surroundings, but rather only snapshots at individual measuring instants.

Depending on the design of the driver-assistance systems in detail, reactions can be produced immediately by the evaluation of the measurement data, such as the actuation of the brake, or making the vehicle driver aware of a necessary reaction by warning signals.

A further difficulty in the evaluation of the measurement data is the circumstance that a faulty triggering must be avoided with a high degree of reliability, for which in turn correspondingly complex evaluation algorithms are necessary. For example, if a situation which requires a braking can only be recognized at an instant which is shortly after a measurement, then the measurement and the evaluation can first give rise to a triggering by one cycle time later. Thus, given this phase position, the cycle time starts between measuring instants and the earliest possible instant of the time in which a reaction is executable.

### SUMMARY OF THE INVENTION

The object of the present invention is to bring about the triggering of a reaction as early on as possible. This objective is achieved by the method of the present invention, in that the measuring instants are controlled in such a way that one of the measuring instants follows as immediately as possible an instant at which measured quantities giving rise to a triggering probably exist. In this context, preferably the measuring instants are controlled as a function of a prediction of the instant.

Using the present invention, already in a phase approaching a critical situation in which no reaction may justifiably yet take place, the phase position of the measuring instant is suitably adjusted based on an estimation of the most probable scenario.

In one advantageous embodiment of the present invention, faster algorithms are used for predicting the instant than for triggering the reaction. In this context, estimates of the instant may already be carried out early on, it not being necessary that the reliability required for trigging the reaction be present. In the event of a false estimation, only the advantage attainable with the present invention is reduced if, namely, the adjustment of the phase position does not optimally succeed.

A suitable lengthening or shortening of the cycle time is necessary for adjusting the phase position. This may preferably be accomplished, in that the control of the measuring instants is implemented by altering the run length of computer programs for evaluating the measurement data, particularly altering the run length via the number of refresh cycles. In this case, no shortening or simplification of the program for evaluating the measurement data for triggering the reaction, and, with it, a decrease in reliability, is necessary. A number of refresh cycles which is possibly too small short-term may be compensated for, given the presence of another situation in which the cycle time is lengthened.

Depending on the implementation of the present invention in detail, a number of further measures are available to one skilled in the art for controlling the measuring instants, i.e., lengthening or shortening the cycle time. In practically implemented driver-assistance systems, not only the evaluation of measured quantities for the purpose of triggering a reaction is carried out by a microcomputer, but also a number of other measures whose safety relevance, at least short-term, is substantially below that of triggering the reaction. They are, for example, comfort functions such as an adaptive cruise control or service functions.

Thus, one possibility for shortening or lengthening the cycle time is, for example, to reduce or expand the measured-quantity resolution or the visual range of the sensors or the number of objects to which attention is given (attention control). In this context, one skilled in the art will essentially utilize those functions for controlling the cycle time which merely promote comfort. Functions which are not time-critical, like the refresh cycles indicated above, may be inserted more or less frequently into the program of the microcomputer accordingly, e.g., at each tenth cycle.

Various reactions may be triggered using the method of the present invention; in particular, the reaction may be an intervention into the guidance of the vehicle and/or the reaction may include warning signals and/or the reaction may include occupant-restraint measures.

The present invention further includes a system for controlling the driver-assistance device, characterized in that means are provided which control the measuring instants in such a way that one of the measuring instants follows as immediately as possible an instant at which measured quantities giving rise to a triggering probably exist, it preferably being provided that the measuring instants are controlled as a function of a prediction of the instant.

The system of the present invention may be designed in such a way that at least one of the sensors is a radar sensor and/or a video sensor and/or a lidar sensor. Various combinations of these or other sensors are possible.

### BRIEF DESCRIPTION OF THE DRAWINGS

FIG. 1 shows a flow chart for illustrating the method according to the present invention.

FIG. 2 shows a system according to the present invention

FIG. 3 shows a schematic representation of vehicles and measuring instants in carrying out the method of the present invention.

### DETAIL DESCRIPTION

The depiction of the method of the present invention in FIG. 1 represents at the same time a program for a microcomputer, present in the driver-assistance system, together with its components necessary for clarifying the present invention.

In a first step 1, the sensor signals are preprocessed, causing, for example, signals of various sensors in each case to be available in an evaluable form as measurement data for later evaluation. At 2, the measurement data are transferred to a program 3 for evaluating the measurement data. The three segments, i.e., programs 1 to 3, each require a processing duration which add up altogether to one cycle time. At the conclusion of the evaluation at 3, a branching takes place at 4 depending upon whether a triggering criterion is reached. If this is the case, the specific reaction, e.g., a braking, is triggered at 5, and the measuring cycle is repeated at 1.

However, if the triggering criterion is not yet reached at 4, a prediction of triggering instants is subsequently carried out at 6. If one of the measuring instants to be expected using the previously set cycle time tz is favorably situated for the predicted triggering instant, tz remains unchanged and the program is repeated at 1. However, if the measuring instant is not favorable, depending on the requirement, the cycle time is lengthened or shortened at 8, and the program is repeated with the altered cycle time.

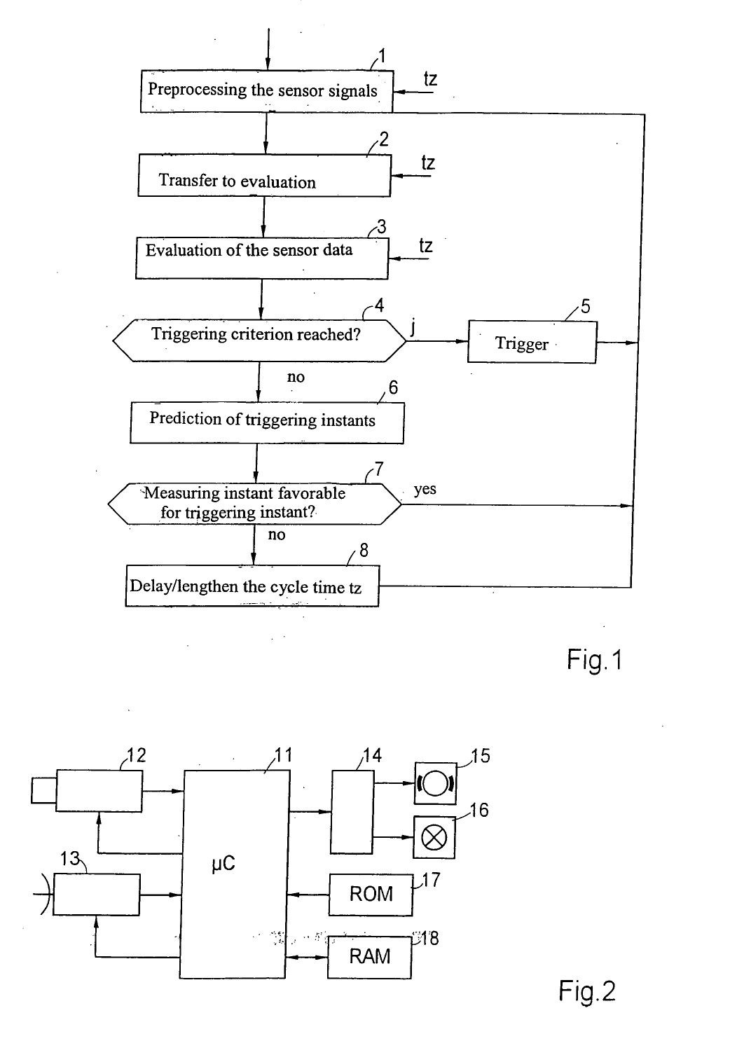

FIG. 2 shows a block diagram of a system according to the present invention having a microcomputer 11 which undertakes all functions necessary for the operation of the system, especially the execution of the programs shown in FIG. 1. Various sensors are connected to the microcomputer, in the case of the exemplary embodiment according to FIG. 2, a video sensor 12 and a radar sensor 13. Sensors 12, 13 may be controlled with respect to their function, including the speed of the preprocessing, by microcomputer 11. The results of the evaluation by microcomputer 11 may be output via an output interface 14, for example, to braking system 15 or to a signal transmitter 16. The programs necessary for operating the system are stored in a read-only memory 17, while a read/write memory 18 serves the microcomputer as a working memory and, among other things, also stores the cycle time set in each case.

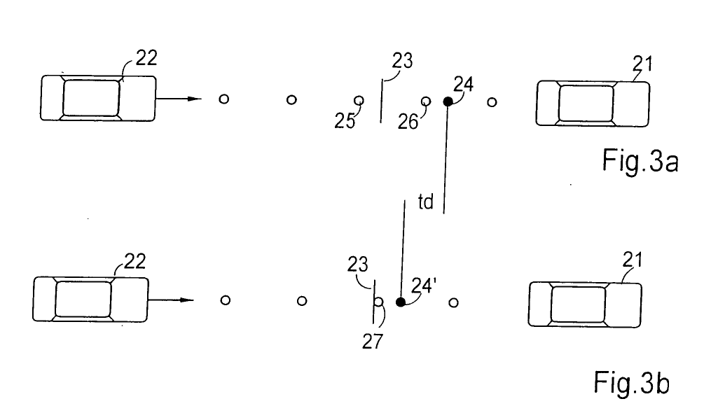

FIGS. 3a and 3b show a first vehicle 21, followed by a second vehicle 22 in the direction of the arrow. Lines 23 indicate a location at which the driver-assistance system is able to recognize that a triggering is necessary if, for example, vehicle 22 is coming too close to vehicle 21 because of higher speed. These instants at which measured quantities giving rise to a triggering are probably detectable for the sensors are in the time plane.

Locations—i.e., instants, taking into account the movement —at which measurements are carried out are designated by circles. Locations 24, at which a triggering takes place after a measurement because of the computing time, are represented as circular disks 24, 24′.

In the exemplary embodiment shown in FIGS. 3a and 3b, it is assumed that, besides the evaluation, other functions also run in a microcomputer. That is why locations 24, 24′are between the preceding measuring location 26, 27 and the following measuring location. However, the present invention is not limited to this, but rather may also be advantageously realized if a computer program merely performs the functions necessary according to the present invention for triggering the reaction. It is even possible to distribute the functions over several microcomputers, e.g., the preprocessing of the sensor data and the further evaluation which leads to the triggering, so that the measuring cycle can be shorter than the evaluation time.

FIG. 3a shows the process without the measures of the present invention, in which it coincidentally turns out that a measuring location 25 is situated shortly before line 23. Here, the driver-assistance system is not yet able to recognize the necessity of a triggering. This is first the case at measuring location 26, so that the triggering takes place at 24.

In the practical application of the method according to the present invention shown in FIG. 3b, cycle time tz is controlled in such a way that a measuring instant, i.e., measuring location 27, is situated as immediately as possible after the ideal location 23 for a triggering. After the system-inherent delay time, the triggering is then implemented at 24′. From the figures, it is discernible that due to the method of the present invention, a time difference td, i.e., a distance gain is achieved.

1.-13. (canceled)

14. A method for controlling a driver-assistance device, comprising:
evaluating measured quantities, to be recorded by sensors, for triggering a reaction;
determining measuring instants through repeating cycles for acquiring and evaluating the measured quantities; and
controlling the measuring instants in such a way that one of the measuring instants follows as immediately as possible an instant at which measured quantities giving rise to a triggering probably exist.

15. The method as recited in claim 14, wherein the measuring instants are controlled as a function of a prediction of the instant.

16. The method as recited in one of claim 14, wherein a faster algorithm is used for predicting the instant than for triggering the reaction.

17. The method as recited in claim 14, wherein the measuring instants are controlled by altering a run length of a computer program for evaluating measurement data.

18. The method as recited in claim 17, further comprising:
altering the run length is altered via a number of refresh cycles.

19. The method as recited in claim 14, wherein the reaction is an intervention into a guidance of a vehicle.

20. The method as recited in claim 14, wherein the reaction includes a warning signal.

21. The method as recited claim 14, wherein the reaction includes an occupant restraint measure.

22. A system for controlling a driver-assistance device, comprising:
an arrangement for evaluating measured quantities, to be recorded by sensors, for triggering a reaction;
an arrangement for determining measuring instants through repeating cycles for acquiring and evaluating the measured quantities; and
an arrangement for controlling the measuring instants in such a way that one of the measuring instants follows as immediately as possible an instant at which measured quantities giving rise to a triggering probably exist.

23. The system as recited in claim 22, wherein the measuring instants are controlled as a function of a prediction of the instant.

24. The system as recited in claim 22, wherein at least one of the sensors is a radar sensor.

25. The system as recited in claim 22, wherein at least one of the sensors is a video sensor.

26. The system as recited in claim 22, wherein at least one of the sensors is a lidar sensor.
